(19) United States
(12) Patent Application Publication
(10) Pub. No.: US 2024/0334242 A1
(43) Pub. Date: Oct. 3, 2024

(54) CONTROL APPARATUS, CONTROL METHODS AND NON-TRANSITORY COMPUTER-READABLE STORAGE MEDIUM

(71) Applicant: CANON KABUSHIKI KAISHA, Tokyo (JP)

(72) Inventor: MIZUHO AOYAGI, Tokyo (JP)

(21) Appl. No.: 18/741,128

(22) Filed: Jun. 12, 2024

Related U.S. Application Data
(63) Continuation of application No. PCT/JP2022/039720, filed on Oct. 25, 2022.

(30) Foreign Application Priority Data
Dec. 14, 2021 (JP) 2021-202772

(51) Int. Cl. H04W 28/02; H04W 28/12; H04W 88/08

(52) U.S. Cl. CPC H04W 28/0273; H04W 28/12; H04W 88/08

(57) ABSTRACT

There is provided A control apparatus for an IAB (Integrated Access and Backhaul) network, comprising: determination unit configured to determine, for each of one or more IAB nodes in the IAB network, a condition for an amount of data being buffered in a downlink buffer of an IAB node relaying a connection between an IAB donor and user equipment via a backhaul link, by which the IAB node triggers execution of flow control processing of downlink traffic on a route including the IAB node, the determining being performed based on a network configuration of the IAB network; and notification unit configured to notify each of the one or more IAB nodes of the condition determined by the determination unit.

### CROSS-REFERENCE TO RELATED APPLICATIONS

This application is a Continuation of International Patent Application No. PCT/JP2022/039720, filed Oct. 25, 2022, which claims the benefit of Japanese Patent Application No. 2021-202772, filed Dec. 14, 2021, both of which are hereby incorporated by reference herein in their entireties.

### BACKGROUND OF THE INVENTION

### Field of the Invention

The present invention relates to a control apparatus, control methods and a non-transitory computer-readable storage medium.

### Background Art

In the 3GPP (3rd Generation Partnership Project), standardization of IAB (Integrated Access and Backhaul) is progressing as a communication technology for backhaul. IAB technology is technology that uses millimeter wave wireless communication such as the 28 GHz band, which is used for access communication between a base station and a user device (UE: User Equipment), as backhaul communication (PTL 1).

In a backhaul communication network using IAB technology (hereinafter referred to as an IAB network), a relay device called an IAB node relays communication from an IAB donor, which corresponds to a conventional base station, to a destination UE.

### CITATION LIST

### Patent Literature

PTL1: Japanese Patent Laid-Open No. 2019-534625

Here, if the IAB network is constituted by including a plurality of IAB nodes, congestion between an IAB donor and a higher-level IAB node will affect communication on the entire IAB network. For this reason, flow control processing between an IAB node and an IAB donor is executed as a countermeasure against congestion.

### SUMMARY OF THE INVENTION

The present invention has been made in view of the above-mentioned problems, and an object of the present invention is to provide a technique for appropriately executing flow control processing in an IAB network.

In order to solve the above-described problem, a control apparatus for an IAB (Integrated Access and Backhaul) network, comprises: a memory for storing one or more programs; and at least one processor that executes the one or more programs to function as: a determination unit configured to determine, for each of one or more IAB nodes in the IAB network, a condition for an amount of data being buffered in a downlink buffer of an IAB node relaying a connection between an IAB donor and user equipment via a backhaul link, by which the IAB node triggers execution of flow control processing of downlink traffic on a route including the IAB node, the determining being performed based on a network configuration of the IAB network; and a notification unit configured to notify each of the one or more IAB nodes of the condition determined by the determination unit.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a diagram showing an example of an IAB network according to the present embodiment.

FIG. 2 is a hardware functional block diagram of an IAB donor 101 and IAB nodes 102 to 105 according to the present embodiment.

FIG. 3 is a software functional block diagram of the IAB donor 101 and the IAB nodes 102 to 105 according to the present invention.

FIG. 4 is an explanatory diagram of an IAB network configuration and a buffer load according to a first embodiment.

FIG. 5 is a flowchart showing an example of threshold determination processing according to the first embodiment.

FIG. 6A is a sequence diagram showing threshold determination processing and processing performed when a threshold is exceeded, according to the first embodiment.

FIG. 6B is a sequence diagram showing threshold determination processing and processing performed when a threshold is exceeded, according to the first embodiment.

FIG. 7 is an explanatory diagram of an IAB network configuration and a buffer load according to a second embodiment.

FIG. 8 is a flowchart illustrating an example of threshold determination processing according to the second embodiment.

FIG. 9 is a sequence diagram showing threshold determination processing and processing performed when the threshold is exceeded according to the second embodiment.

FIG. 10 is a diagram showing an example of an IAB network according to the present embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

In an IAB (Integrated Access and Backhaul) network according to this embodiment, control is performed between an IAB donor and an IAB node, and between a higher-level IAB node and a lower-level IAB node via a BAP (Backhaul Adaptation Protocol).

The control device also notifies each IAB node of a condition regarding the amount of data being buffered in the buffer of the IAB node. Each IAB node transmits a notification to the control device when the amount of data being buffered in the buffer satisfies the condition, and as a result, flow control processing is executed in the IAB network. In this embodiment, the control device will be described as being a CU (Central Unit) of the IAB donor, but the control device may also be provided in a network node different from the IAB donor.

Instruction of flow control processing is also supported at the BAP layer, and an IAB node can transmit, to its parent node, feedback information regarding the buffer size available for the input BH RLC (Backhaul Radio Link Control) channel or BAP sublayer address. The parent node can transfer feedback information regarding the available buffer size to the IAB donor. Feedback can be transmitted in advance when the buffer load exceeds a certain threshold or based on polling by the parent node, and flow control processing can be executed using this buffer threshold as a trigger.

This embodiment describes an example of dynamically setting a threshold for notifying an IAB donor that the amount of data being buffered in a buffer of an IAB node (buffer data amount) has exceeded a threshold (buffer threshold).

### First Embodiment

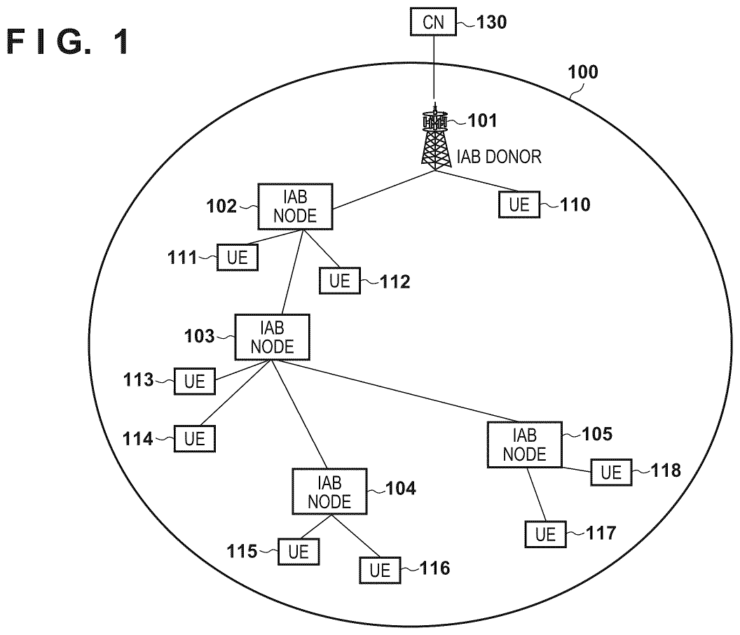

FIG. 1 is a diagram showing an example of an IAB network according to this embodiment. In an IAB network 100, there is an IAB donor 101 that provides a connection to a CN (core network) 130, and the IAB donor 101 forms an IAB network including IAB nodes 102 to 105. Here, the CN is responsible for various processes such as authentication of UEs (user equipment) 110 to 119, which are terminals.

The IAB donor 101 performs overall control of the IAB nodes 102 to 105, forms an area covered by its own station, and provides network access via an access link to the UEs 110 to 119 connected to the IAB donor 101.

Within the IAB network 100, communication packets (hereinafter referred to as BAP data packets) conforming to the format of a BAP (Backhaul Adaptation Protocol) data PDU (Protocol Data Unit) are used as communication packets. For example, an IP (Internet Protocol) packet whose destination is the UE 118 from the CN 130 is converted into a BAP data packet in the IAB donor 101 and is transferred into the IAB network 100. The transferred BAP data packet is converted to an IP packet again at the IAB node 105 via the IAB nodes 102 to 105 and is delivered to the destination UE 118. Similarly, an IP packet from the UE 118 is also converted into a BAP data packet by the IAB 105, is converted into an IP packet again by the IAB donor 101 via the IAB network 100, and is transferred to the CN 130.

The IAB nodes 102 to 105 have buffers and utilize the buffers to store BAP data packets. In one example, the IAB nodes 102 to 105 have separate uplink buffers for storing BAP data packets for uplink traffic and downlink buffers for storing BAP data packets for downlink traffic. Furthermore, in the IAB network 100, the IAB donor 101 sets conditions regarding the amount of data being buffered in the buffer using the BAP data packet for the subordinate IAB nodes 102 to 105. In the example below, a threshold is set as a condition regarding the amount of data, and when the amount of data being buffered in any buffer of the IAB nodes 102 to 105 satisfies the condition, notification is performed to the IAB donor 101. Based on the notification, the IAB donor 101 executes flow control regarding traffic passing through the IAB node that transmitted the notification.

The following describes a method for setting a buffer threshold for each IAB node in order to efficiently implement communication in the entire IAB network in a network including the IAB nodes 102 to 105, such as the IAB network 100 shown in FIG. 1.

Note that this embodiment describes downlink communication in which communication packets from the CN 130 are transferred to the UEs 102 to 105 via the IAB donor 101.

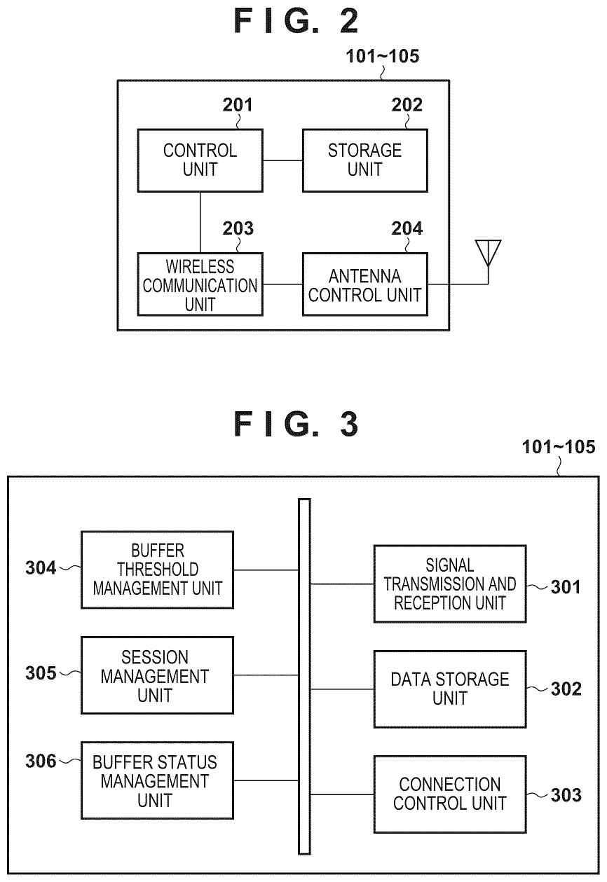

FIG. 2 is a hardware functional block diagram of the IAB donor 101 and the IAB nodes 102 to 105 in the present invention.

The IAB donor 101 and the IAB nodes 102 to 105 each include a control unit 202, a storage unit 203, a wireless communication unit 204, and an antenna control unit 205. The control unit 202 controls the entire device by executing a control program stored in the storage unit 203.

The storage unit 203 stores various types of information such as the control program to be executed by the control unit 202, information on the UEs connected to the device, and the buffer usage status. The IAB donor 101 also stores network configuration information of the IAB nodes 102 to 105 in the storage unit 203. In the case of a tree topology, the network configuration information includes identifiers of parent nodes and child nodes, identifiers of IAB nodes forming a route (path), and information on user equipment connected to the IAB nodes 102 to 105.

The wireless communication unit 204 is a wireless communication unit for performing cellular network communication such as LTE and 5G that conforms to the 3GPP standard. Also, the wireless communication unit 204 has a buffer for use in backhaul communication (a backhaul link buffer for connection between nodes). Also, the IAB donor 101 may additionally include a communication unit for connection to a core network. The antenna control unit 205 controls an antenna used for wireless communication executed by the wireless communication unit 204.

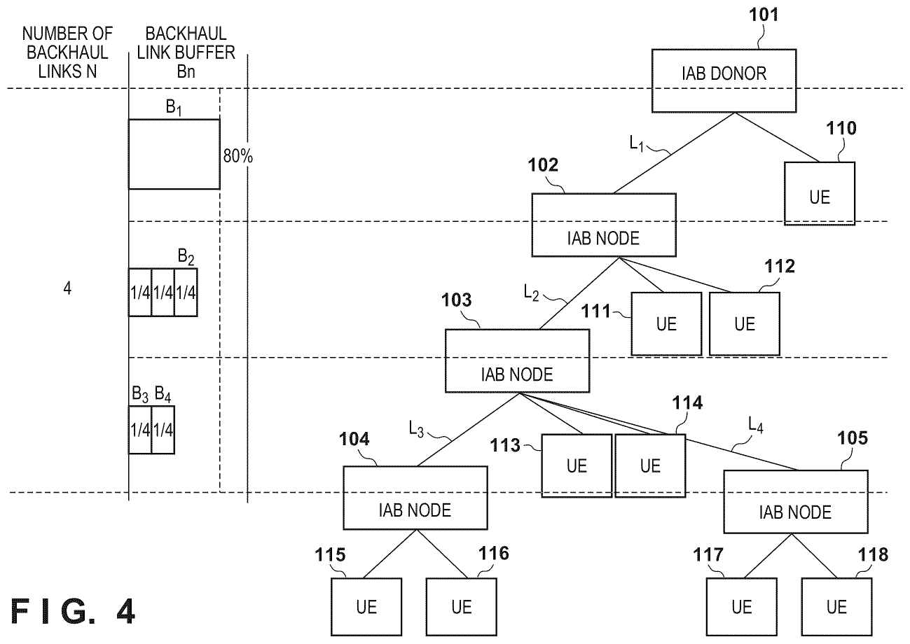

FIG. 3 is a software functional block diagram of the IAB donor 101 and the IAB nodes 102 to 105 according to this embodiment. The software functional blocks shown in FIG. 3 include a signal transmission and reception unit 301, a data storage unit 302, a connection control unit 303, a buffer threshold management unit 304, a session management unit 305, and a buffer status management unit 306. These software functional blocks are realized by the IAB donor 101 and the control units 201 of the IAB nodes 102 to 105 executing programs stored in the storage unit 202 to control the entire device.

Note that some software function blocks may also be omitted depending on the device. For example, the IAB donor 101 may have all of the software functional blocks, while the IAB nodes 102 to 105 need not have the buffer threshold management unit 304, the session management unit 305, and the buffer status management unit 306.

The signal transmission and reception unit 301 controls the wireless communication unit 203 via the control unit 201, and executes cellular network communication such as LTE and 5G conforming to the 3GPP standard, with the IAB nodes 102 to 105 and the UEs 110 to 119. The data storage unit 302 controls and manages the storage unit 203, which is an entity, and stores and holds the software itself, routing information of the IAB nodes 102 to 105, information regarding the UEs 110 to 118, and the like.

The connection control unit 303 controls the antenna control unit 205 via the control unit 202 during wireless communication. The buffer threshold management unit 304 determines the buffer threshold to be set for each IAB node from the information of the session management unit 305 and buffer status management unit 306 collected in the IAB donor 101, and notifies each IAB node of the threshold. The session management unit 305 stores and manages information (number, number of node stages, number of backhaul links) on the IAB nodes and the UEs connected to the IAB donor 101 and the IAB nodes 102 to 105.

The buffer status management unit 306 stores and manages the buffer sizes that are available at each IAB node, the buffer sizes being collected from the IAB nodes 102 to 105. Note that the buffer status information is collected by, for example, a BAP data packet or a communication packet (hereinafter referred to as a BAP control packet) according to various control PDUs of the BAP.

The buffer threshold management unit 304, the session management unit 305, and the buffer status management unit 306 hold the most recent information for each IAB node, and past information is stored in the data storage unit 302. A detailed method for determining the buffer threshold will be described later.

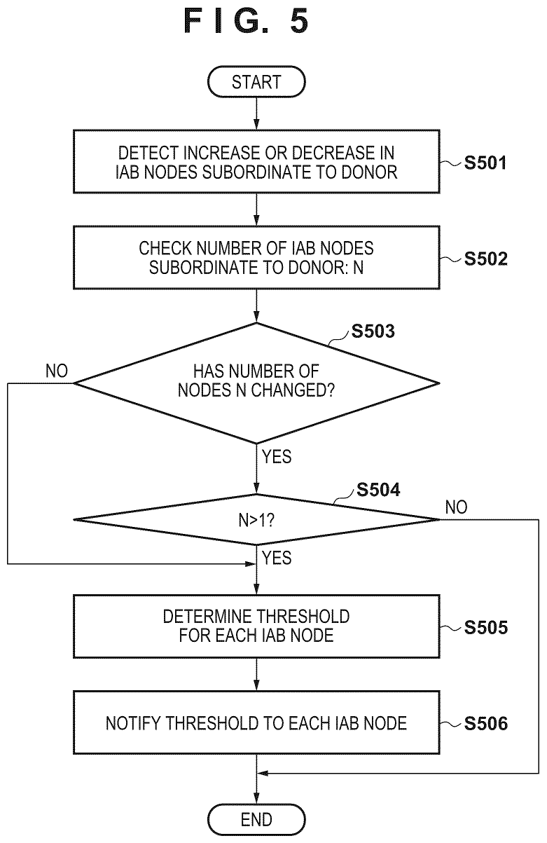

FIG. 4 is a diagram showing a network configuration of the IAB network 100 and an example of setting buffer thresholds to be set for the IAB nodes 102 to 105, according to the first embodiment. In the IAB network 100, buffers (backhaul link buffers) ensured in inter-node links from the IAB donor 101 to each of the IAB nodes 102 to 105 are expressed as L1 to L4. Note that the description will be given assuming that the backhaul link buffer shown in FIG. 4 is a downlink buffer used for downlink communication from the IAB donor 101 to the UEs 110 to 118.

In the first embodiment, the IAB donor 101 determines the buffer threshold (B) of each IAB node according to the number (N) of IAB nodes connected on the communication route of the IAB network 100, and the buffer thereof is used equally by the connected IAB nodes.

In the example in FIG. 4, the number of IAB nodes 102 to 105 that connect to the IAB donor 101 via the downlink buffer L1, which is the connection between the IAB donor 101 and the IAB node 102, is four, and therefore the buffer is used equally with N=4. For example, if the available upper limit of the downlink buffer L1 is B1, which is the buffer size at which 80% of the bandwidth is available within the IAB network 100, the link buffer B1 of the IAB node 102 directly connected to L1 can be determined according to Formula 1 below.

$$B 1 = 4 / 5 \times L 1 \qquad ( 1 )$$

Also, the upper limit Bn (n=1 to 4) of the buffer size available to each IAB node on Ln (n=1 to 4) can be determined according to Formula (2) below.

$$B n = B 1 \times 1 / N \qquad ( 2 )$$

If the available buffer size is different for each IAB node due to hardware and software specifications, the upper limit is set to 80% of the buffer size for each node, and the smaller one of Bn and 80% of the buffer size for each node is set as the buffer size.

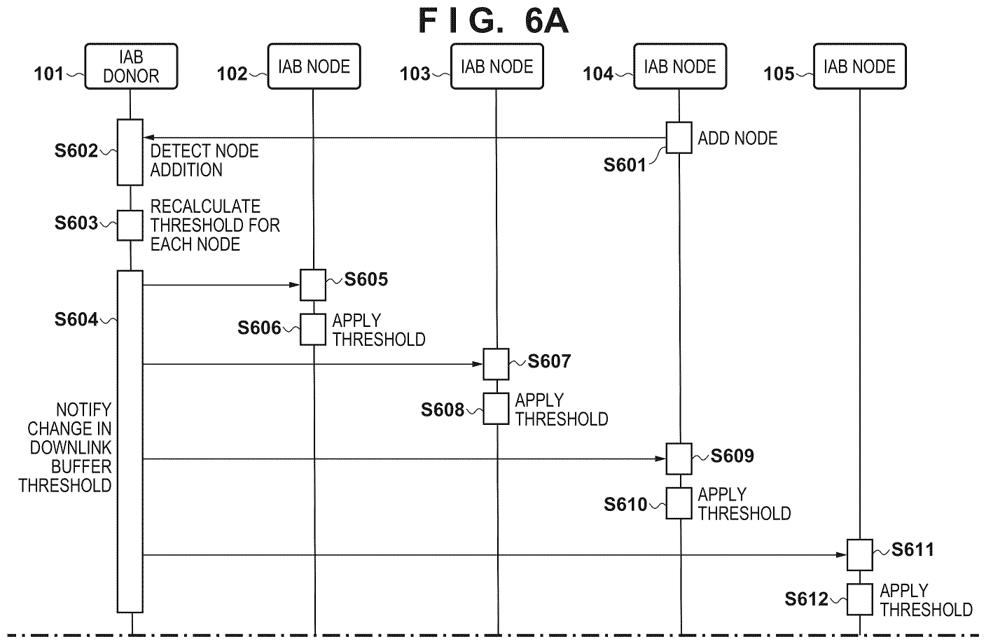

FIG. 5 is a flowchart illustrating a method for determining a threshold at an IAB donor in accordance with an increase or decrease in the number of IAB nodes according to the first embodiment. The processing shown in FIG. 5 is executed at predetermined time intervals.

In step S501, the IAB donor 101 detects an increase or decrease in the number of IAB nodes within the IAB network 100. Subsequently, in step S502, the IAB donor 101 checks the number (N) of IAB nodes in the IAB network 100.

In step S503, it is checked whether or not there is a change in the number of IAB nodes in the IAB network 100. If there is a change (Yes in step S503), it is checked in step S504 whether or not the number N of IAB nodes exceeds 1. If there is no change in the number N of nodes in step S502 (No in step S503), and if the number N of IAB nodes exceeds 1 in step S504 (Yes in step S504), buffer thresholds for the IAB nodes 102 to 105 are determined in step S505. If the number N of IAB nodes does not exceed 1 in step S504 (No in step S504), the processing is ended.

In step S506, the determined buffer threshold is notified to the IAB nodes 102 to 105, and the processing is ended. The details of the processing of step S505 may also be determined for each of the IAB nodes 102 to 105 according to the number of IAB nodes connected to the IAB donor 101 via the IAB nodes 102 to 105, as shown in FIG. 4.

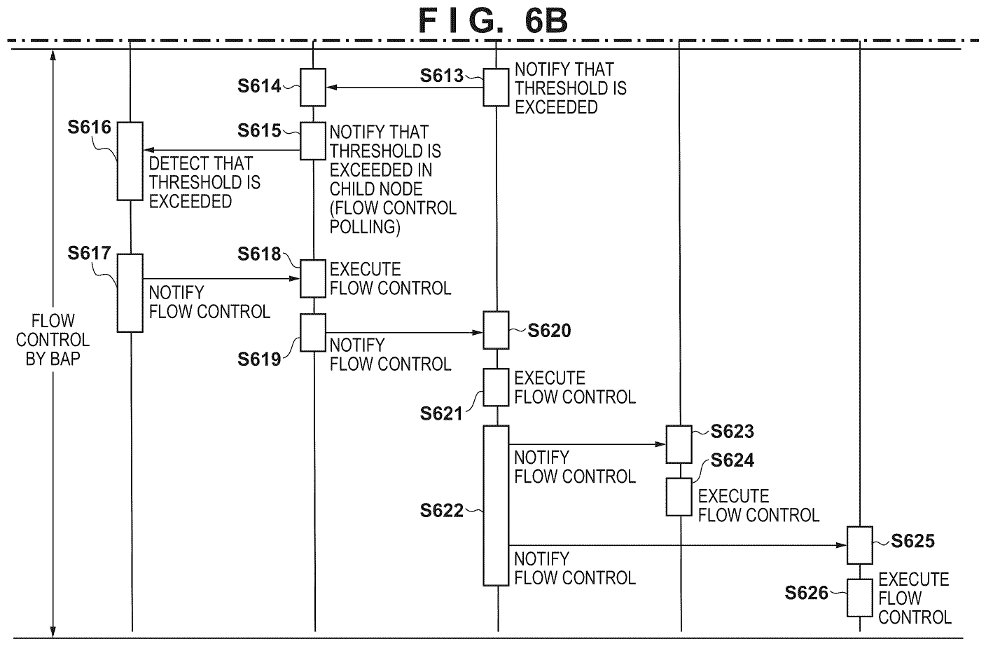

FIGS. 6A and 6B are sequence diagrams showing a method for resetting a buffer threshold for an IAB node, a notification method, and processing performed when the threshold is exceeded, which are executed when the IAB donor detects an increase or decrease in the number of IAB nodes. Here, the processing for detecting an increase or decrease in the number of nodes, recalculating the buffer thresholds for all IAB nodes in the IAB network 100, performing notification of the buffer threshold, and receiving a notification that triggers execution of flow control processing from the IAB node when the threshold is exceeded will be described. In the examples of FIGS. 6A and 6B, description will be given assuming that the IAB donor 101 detects that the IAB node 104 has connected to the IAB donor 101 within a predetermined time.

In step S601, the IAB node 104 connects to the IAB network 100 by transmitting a notification such as a connection request to the IAB donor 101. In step S602, the IAB node 101 receives a notification from the IAB node 104 and detects that the IAB node 104 has been added to the IAB network 100.

In step S603, the IAB donor 101 recalculates and determines the buffer thresholds to be set for each of the IAB nodes 102 to 105 in the IAB network 100 in accordance with the change in the number of IAB nodes connected to the IAB donor 101. The processing of step S603 has been described with reference to FIG. 4, and therefore the details thereof will be omitted. In step S604, the IAB node 101 notifies the IAB nodes 102 to 105 of the determined buffer thresholds.

In steps S605, S607, S609, and S611, each of the IAB nodes 102 to 105 receives a buffer threshold change notification. In steps S606, S608, S610, and S612, each of the IAB nodes 102 to 105 applies the received buffer threshold as its buffer threshold. Next, processing performed when the buffer threshold is exceeded in the IAB node in steps S613 to S626 will be described. Steps S613 to S626 will be described assuming that the IAB node 103 detects that the buffer threshold has been exceeded.

In steps S613 and S614, the IAB node 103 recognizes that the buffer threshold has been exceeded and notifies the IAB node 102 that the buffer threshold has been exceeded. The notification in step S613 is performed using a BAP message, and is a message that triggers execution of the flow control processing according to this embodiment. In step S614, the IAB node 102 detects that the IAB node 103 connecting to the IAB donor 101 via the IAB node 102 has exceeded the threshold. In steps S615 and S616, the IAB donor 101 receives a notification from the IAB node 102 indicating that the IAB node 103 has exceeded the buffer threshold, and thereby the IAB donor 101 detects that the IAB node 103 has exceeded the buffer threshold. This triggers execution of flow control processing in the IAB network 100.

In step S617, the IAB donor 101 transmits an instruction to execute flow control processing to the IAB node 102, and in step S618, the IAB node 102 executes the flow control processing.

In step S619, the IAB node 102 transmits an instruction to execute flow control processing to IAB node 103, and in step S620, the IAB node 103 specifies flow control processing, and in step S621, executes flow control processing. In step S621, the IAB node 103 executes flow control processing.

Subsequently, in step S622, the IAB node 103 notifies the IAB nodes 104 and 105 of flow control. In steps S623 and S625, the IAB nodes 104 and 105 detect an instruction to execute flow control processing. In steps S624 and S626, the IAB nodes 104 and 105 perform flow control.

The flow control processing instructed in step S617 may also be different depending on the position of the IAB node where the downlink buffer threshold has been exceeded.

For example, the IAB node 102, which is the node through which the IAB node 103 whose amount of data buffered in the downlink buffer has exceeded the threshold connects to the IAB donor 101, may reduce the amount of downlink data transferred to the IAB node 103. As a result, it is possible to perform an operation so as to reduce the amount of data buffered in the downlink buffer of the IAB node 103.

Also, the IAB node 103 whose amount of data buffered in the downlink buffer has exceeded the threshold may change its data transmission policy so as to preferentially transmit data to a node or user equipment with high communication quality, such as a low packet loss rate. As a result, it is possible to reduce the amount of data buffered in the downlink buffer.

Also, the IAB nodes 104 and 105 that connect to the IAB donor 101 via the IAB node 103 may change their communication scheduling so as to preferentially receive downlink transmission from the IAB node 103. As a result, it is possible to preferentially reduce the amount of data buffered in the downlink buffer of the IAB node 103.

Also, if there is a communication route (path) that does not go through the IAB node 103, the IAB donor 101 may perform route control processing, such as transmitting downlink data to the IAB nodes 104 and 105 without going through the IAB node 103. In one example, the IAB donor 101 may also instruct the IAB nodes 104 and/or 105 to switch connections to the IAB donor 101 or the IAB node 102. As a result, when the IAB network 100 is capable of communicating via multipaths, communication can be performed using a path that does not go through a node where the amount of data buffered in the downlink buffer has exceeded a threshold.

Note that the flow control processing executed by the IAB nodes 102 to 105 may also be instructed by the notification in step S617 from the IAB donor 101. Alternatively, the IAB donor 101 may instruct only the execution of flow control processing, and the processing to be executed may be determined by each IAB node. For example, the IAB donor 101 may determine which IAB node is to execute the flow control processing, depending on the number of times the IAB donor 101 has instructed the execution of the flow control processing in a predetermined period. For example, when executing flow control processing for the first time within a predetermined period, the IAB donor 101 causes only IAB nodes whose amount of data buffered in the downlink buffer has exceeded the threshold to execute flow control processing. Subsequently, when flow control processing is executed for the second time within a predetermined period, the IAB donor 101 may cause also the nodes closer to the IAB donor 101 than the IAB nodes whose amount of data buffered in the downlink buffer has exceeded the threshold to execute the flow control processing. As a result, it is possible to reduce the amount of data buffered in the downlink buffer for more IAB nodes when flow control processing is frequently executed.

As described above, when an increase or decrease in the number of IAB nodes is detected, an appropriate buffer threshold can be determined for each IAB node by determining the buffer threshold for each IAB node according to the number of IAB nodes in the IAB network 100.

### Second Embodiment

The first embodiment described a method in which the IAB donor determines the threshold of the amount of data buffered in the downlink buffer of the IAB node according to the number of IAB nodes that connect to the IAB donor via that IAB node. The second embodiment will describe a method in which a buffer threshold is determined according to the number of communication devices (total number of IAB nodes and UEs) connected to the IAB network. Note that the same reference numerals are used for the same configurations, functions, and processes as in the first embodiment, and descriptions thereof are omitted.

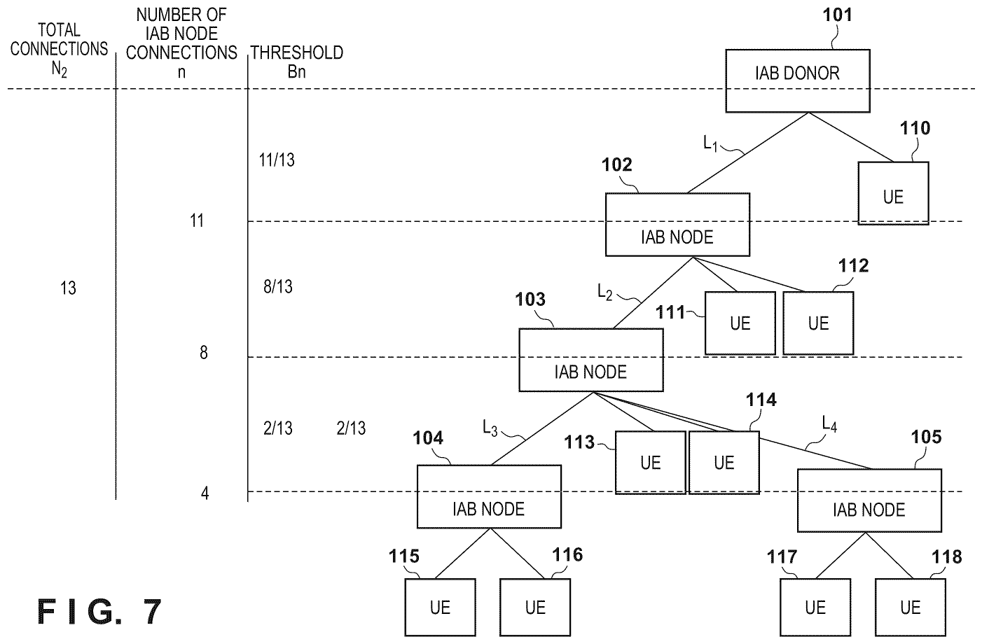

FIG. 7 shows the configuration of an IAB network 100 and a method for determining a buffer threshold for an IAB node according to the second embodiment.

Letting the number of connected devices in the IAB network 100 be N₂, the IAB donor 101 equally distributes network resources to each device. The backhaul link between the IAB donor 101 and the IAB node 102 is denoted as L1, and the backhaul links with subordinate IAB nodes are denoted as L2 to L4. At this time, the number of UEs is 9, namely UEs 110 to 118, the number of IAB nodes is 4, namely IAB nodes 102 to 105, and the number N₂ of connected devices is 13.

Here, if the number of connections for each IAB node is denoted as n, the number n of devices connected to the IAB donor 101 via the IAB node 102 is 11. Similarly, the number n of connections of the IAB node 103 is 8, and the number n of connections of the IAB nodes 104 and 105 is 2. Accordingly, the buffer threshold for each IAB node is also obtained as n/N₂ for the backhaul link buffers L1 to L4. At this time, if the buffer threshold to be set in each IAB node for L1 to L4 is Bi (i=1 to 4), the buffer threshold can be determined according to the following Formula (3).

$$Bi = Li \times n / {N}_{2} \qquad ( 3 )$$

In this way, the buffer threshold of an IAB node with a small number of connected devices is set to be low, and the timing of triggering execution of flow control processing is made earlier. This makes it possible to reduce the influence on communication to the IAB nodes and UEs that are closer to the IAB donor 101 in terms of the network than the IAB node.

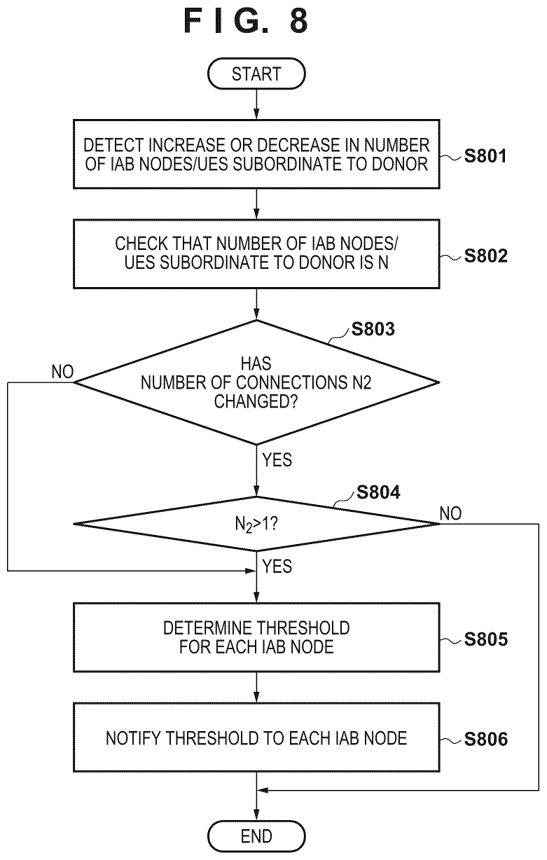

FIG. 8 is a flowchart showing threshold determination processing executed by the IAB donor 101 according to an increase or decrease in the number of IAB nodes or UEs in the second embodiment.

In step S801, the IAB donor 101 detects that the number of IAB nodes and UEs connected to the IAB donor 101 has increased or decreased (changed) by a predetermined number or more within a predetermined time. For example, when a connection request or a handover request is received from either an IAB node or a UE, it is possible to detect that the number of connections between the IAB nodes and the UEs will increase.

In step S802, the IAB donor 101 checks the number (N₂) of connections of the IAB nodes and the UEs connected to the IAB donor 101. In step S803, it is checked whether or not there is a change in the number N₂ of connections of the IAB nodes and the UEs connected to the IAB donor 101. If there is a change (Yes in S803), the IAB donor 101 advances the processing to step S804 and checks whether or not the number N₂ of connections between the IAB nodes and the UEs exceeds 1.

If there is no change in the number N₂ of connections in step S803 (No in step S803), the IAB donor 101 advances the processing to step S805, and the IAB donor 101 determines the buffer thresholds of the IAB nodes 102 to 105. In step S804, if the number N₂ of connections between the IAB nodes and the UEs does not exceed 1 (No in step S804), the IAB donor 101 ends the processing. In step S806, the determined buffer threshold is notified to the IAB nodes 102 to 105, and the processing is ended.

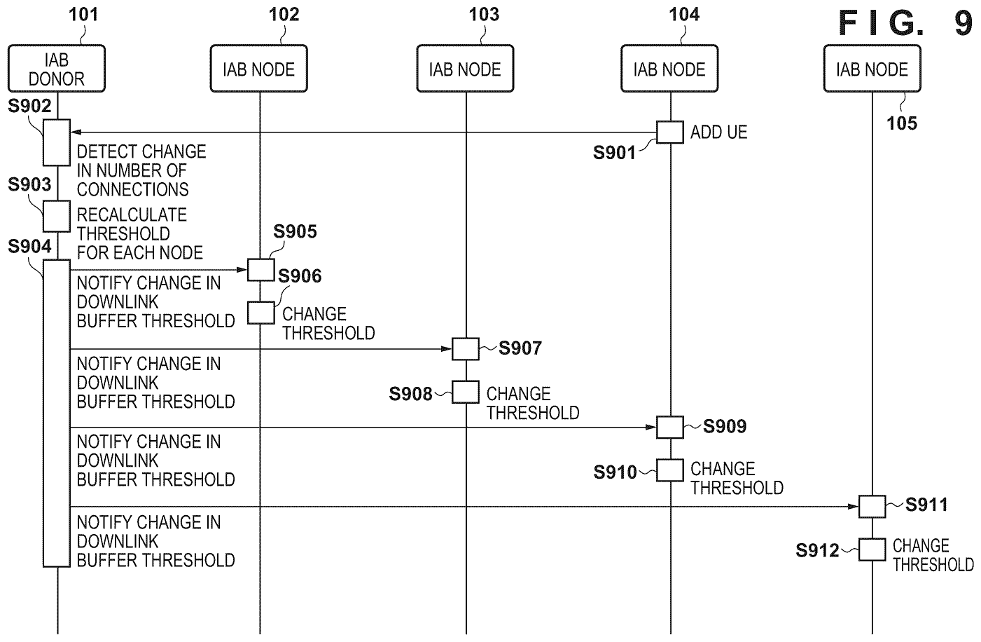

Next, FIG. 9 is a sequence diagram showing buffer threshold determination processing executed by the IAB donor 101 when a UE connects to the IAB node 104 in the IAB network 100.

In step S601, the IAB node 104 is connected to the IAB network 100 and transmits a node addition signal, but in step S901, the IAB node 104 transmits a signal such as a connection request from the UE to the IAB donor 101. The IAB donor 101 detects a change in the number of connections in step S902. The subsequent processing in steps S903 to S912 is similar to that in steps S603 to S612 in FIG. 6A, and therefore detailed description thereof will be omitted.

As described above, when the IAB donor detects that the number of IAB nodes and UEs connected to the IAB donor has changed by a predetermined value within a predetermined time, the IAB donor determines the buffer threshold for each IAB node according to the number of IAB nodes and the number of UEs. As a result, even if the number of UEs connected to each IAB node differs significantly, such as a case where a large number of UEs are connected to a specific IAB node, it is possible to determine a suitable threshold for triggering execution of flow control processing for each IAB node. Also, it is possible to equally allocate the amount of data to be buffered in the downlink buffer to the IAB nodes and the UEs.

Note that in this embodiment, the data amount is allocated uniformly between the IAB nodes and the UEs, but weighting may be applied between the IAB nodes and the UEs. For example, an IAB node may be allocated more data than a UE, such as 10 times more. In the example of FIG. 7, the total number of connections N₂ may be 49 UEs. This allows a larger margin to be ensured in the backhaul link.

According to the present invention, it is possible to provide a technique for appropriately executing flow control processing in an IAB network.

### OTHER EMBODIMENTS

In the first and second embodiments, the description was given assuming that a predetermined IAB node has only one parent node. However, in a multipath IAB network, one IAB node may have a plurality of parent nodes. In such a case, the IAB donor 101 may also determine conditions regarding the amount of data to be buffered in the downlink buffer for each route for each route (path) ID.

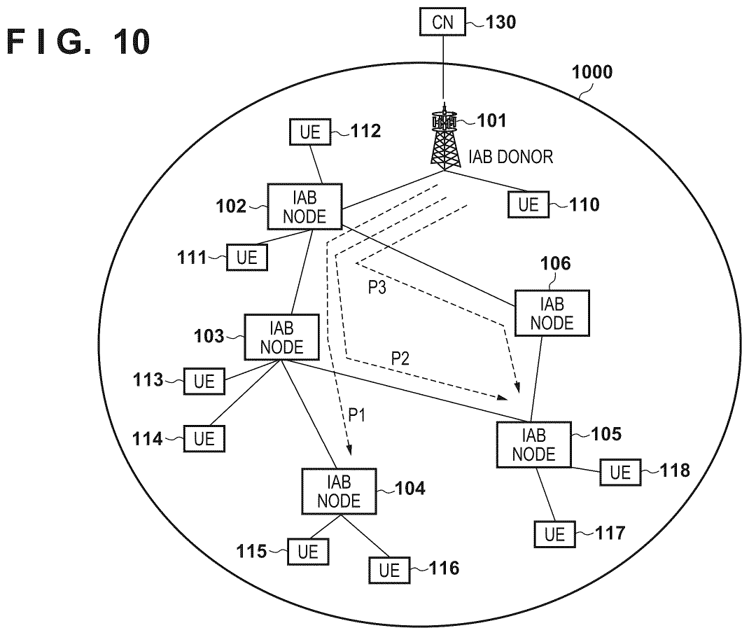

For example, in the IAB network 1000 shown in FIG. 10, a path P1 goes through the IAB nodes 102, 103, and 104, a path P2 goes through the IAB nodes 102, 103, and 105, and a path P3 goes through the IAB nodes 102, 106, and 105. In such an IAB network 1000, a case will be described in which resources are equally allocated to each path, assuming that the upper limit of the buffer threshold is 90%.

If the buffer size allocated to the path P1 is B_{P1}, a buffer threshold of 0.9B_{P1} is allocated to the IAB node 102, a buffer threshold of 0.6B_{P1} is allocated to the IAB node 103, and a buffer threshold of 0.3B_{P1} is allocated to the IAB node 104. Similarly, if the buffer size allocated to path P2 is B_{P2}, a buffer threshold of 0.9B_{P2} is allocated to the IAB node 102, a buffer threshold of 0.6B_{P2} is allocated to the IAB node 103, and a buffer threshold of 0.3B_{P2} is allocated to the IAB node 105. If the buffer size allocated to the path P3 is B_{P3}, a buffer threshold of 0.9B_{P3} is allocated to the IAB node 102, a buffer threshold of 0.6B_{P3} is allocated to the IAB node 106, and a buffer threshold of 0.3B_{P3} is allocated to the IAB node 105.

Next, the IAB donor 101 adds up the buffer thresholds for the IAB nodes through which multiple paths pass. For example, the IAB node 102 is allocated a buffer threshold of 0.9 (B_{P1}+B_{P2}+B_{P3}), and the IAB node 103 is allocated a buffer threshold of 0.6 (B_{P1}+B_{P2}). For this reason, the buffer size of each IAB node can be determined by determining B_{P1}, B_{P2}, and B_{P3} such that 90% of the downlink buffer size of the IAB node 102 is 0.9 (B_{P1}+B_{P2}+B_{P3}). Here, for B_{P1}, B_{P2}, and B_{P3}, for example, buffers may be allocated equally (B_{P1}=B_{P2}=B_{P3}) for each path, or buffers may be allocated to correspond to the length (number of hops) of the path. Also, buffers may be allocated to correspond to the number of UEs connected to each path. Then, B_{P1}, B_{P2}, and B_{P3}, which do not exceed the upper limit of the buffer size of each IAB node, can be specified, and it is possible to determine the threshold of the amount of data to be buffered in the downlink buffer for each IAB node described above.

In the first embodiment, the buffer threshold set for an IAB node was described as being set according to the number of IAB nodes connected to an IAB donor via that IAB node. Also, in the second embodiment, a control method has been described in which a buffer threshold to be set in an IAB node is set according to the number of IAB nodes and UEs that connect to an IAB donor via that IAB node. As another method, a buffer threshold to be set for an IAB node may also be determined according to the number of IAB nodes (number of hops) passed through before that IAB node connects to the IAB donor. For example, if the number of hops to the IAB donor is H and the maximum value of the buffer threshold is B, then B/H may be used. As a result, a larger buffer threshold can be allocated to an IAB node with a smaller number of hops to the IAB donor, that is, an IAB node closer to the IAB donor in terms of the network, and a smaller buffer threshold can be allocated to an IAB node with a larger number of hops to the IAB donor. Note that if there are multiple patterns of the number of hops to the IAB donor, such as in a multipath IAB network, the buffer threshold may be determined based on the smallest number of hops.

According to this method, a threshold for the amount of data buffered in the downlink buffer of an IAB node that is far from the IAB donor is set low to trigger execution of flow control. As a result, in a multi-stage connected IAB network, it is possible to suppress the influence of an IAB node that is farther away in terms of the network from the IAB donor on an IAB node that is closer to the IAB donor and on a UE that connects to the IAB node.

Note that the present embodiment has been described assuming that the IAB node notifies the IAB donor when the amount of data buffered in the downlink buffer exceeds a threshold. However, in one example, an IAB node may transmit a notification to an IAB donor in response to an event regarding the amount of data buffered in the downlink buffer, such as the amount of data buffered in the downlink buffer increasing or decreasing by a predetermined value or more in a predetermined period. That is, the IAB node may trigger execution of the flow control processing when the amount of data buffered in the downlink buffer satisfies a predetermined condition.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A control apparatus for an IAB (Integrated Access and Backhaul) network, comprising:
a memory for storing one or more programs; and
at least one processor that executes the one or more programs to function as:
a determination unit configured to determine, for each of one or more IAB nodes in the IAB network, a condition for an amount of data being buffered in a downlink buffer of an IAB node relaying a connection between an IAB donor and user equipment via a backhaul link, by which the IAB node triggers execution of flow control processing of downlink traffic on a route including the IAB node, the determining being performed based on a network configuration of the IAB network; and
a notification unit configured to notify each of the one or more IAB nodes of the condition determined by the determination unit.

2. The control apparatus according to claim 1, wherein the condition indicates a threshold for the amount of data being buffered in a downlink buffer of each of the one or more IAB nodes.

3. The control apparatus according to claim 2, wherein the determination unit determines the threshold for each of the one or more IAB nodes such that the threshold is smaller than a threshold for an IAB node through which each of the one or more IAB nodes connects to the IAB donor.

4. The control apparatus according to claim 2, wherein the determination unit determines the condition according to the number of IAB nodes through which the IAB donor is connected to.

5. The control apparatus according to claim 2, wherein the determination unit determines the condition for each of the one or more IAB nodes according to the number of IAB nodes that connect to the IAB donor through each of the one or more IAB nodes.

6. The control apparatus according to claim 2, wherein the determination unit determines the condition based on the number of pieces of user equipment connected to the IAB donor via each of the one or more IAB nodes.

7. The control apparatus according to claim 2, wherein the at least one processor is further functions as a reception unit configured to receive notification indicating that the amount of data being buffered in a downlink buffer of a first IAB node among the one or more IAB nodes has exceeded the threshold.

8. The control apparatus according to claim 7, the at least one processor is further functions as a transmission unit configured to transmit an instruction to reduce the amount of downlink data to be transferred to the first IAB node from the IAB node through which the first IAB node connects to the IAB donor.

9. The control apparatus according to claim 7, the at least one processor is further functions as a route control unit configured to change a communication route of a data packet so as to reduce the amount of downlink data to be transferred to the first IAB node.

10. The control apparatus according to claim 1, wherein the condition includes the amount of data being buffered in a downlink buffer of each of the one or more IAB nodes increasing or decreasing by a predetermined value or more within a predetermined period.

11. The control apparatus according to claim 1, the at least one processor is further functions as a detection unit configured to detect that an IAB node and user equipment connected to the IAB donor have changed within a predetermined time,
wherein the determination unit determines the condition if the detection unit detects that an IAB node and user equipment have changed within the predetermined time.

12. A control method of an IAB node to be connected to an IAB donor of an IAB (Integrated Access and Backhaul) network via a backhaul link, comprising:
receiving, from a control apparatus for the IAB network, a condition for an amount of data being buffered in a downlink buffer of the IAB node, the condition being for triggering execution of flow control processing of downlink traffic on a route including the IAB node and controlling the IAB node to store the received condition in a predetermined storage area of the IAB node;
notifying a higher-level IAB node of a message for triggering execution of flow control processing using BAP (Backhaul Adaptation Protocol) message in a case where the condition stored in the predetermined storage area is satisfied; and
controlling the IAB node, in a case of receiving from the control apparatus a notification for changing a condition of an amount of data, to update the condition of an amount of data stored in the predetermined storage area based on the received notification for changing the condition,
wherein the notification for changing the condition is transmitted to the IAB node in a case where the control apparatus recalculates a condition of an amount of data by taking into account changes in a communication condition in the IAB network.

13. A control method of a control apparatus for an IAB (Integrated Access and Backhaul) network, comprising:
determining, for each of one or more IAB nodes in the IAB network, a condition for an amount of data being buffered in a downlink buffer of the IAB node relaying a connection between an IAB donor and user equipment via a backhaul link, by which the IAB node triggers execution of flow control processing of downlink traffic on a route including the IAB node, the determining being performed based on a network configuration of the IAB network; and
notifying each of the one or more IAB nodes of the determined condition.

14. A non-transitory computer-readable storage medium storing instructions for causing a computer of a control apparatus for an IAB (Integrated Access and Backhaul) network to execute a method comprising:
determining, for each of one or more IAB nodes in the IAB network, a condition for an amount of data being buffered in a downlink buffer of an IAB node relaying a connection between an IAB donor and user equipment via a backhaul link, by which the IAB node triggers execution of flow control processing of downlink traffic on a route including the IAB node, the determining being performed based on a network configuration of the IAB network; and
notifying each of the one or more IAB nodes of the determined condition.
